(19) United States
(12) Patent Application Publication
(10) Pub. No.: US 2025/0171350 A1
(43) Pub. Date: May 29, 2025

(54) ION EXCHANGE APPARATUS FOR GLASS STRENGTHENING AND METHOD OF FABRICATION

(71) Applicant: Honeywell Federal Manufacturing & Technologies, LLC, Kansas City, MO (US)

(72) Inventors: Rachel Grodsky, Kansas City, MO (US); Matthew Hodges, Kansas City, MO (US); James Colby, Kansas City, MO (US); Gregory Thompson

(21) Appl. No.: 18/523,059

(22) Filed: Nov. 29, 2023

(51) Int. Cl. C03C 21/00

(52) U.S. Cl. CPC C03C 21/00

(57) ABSTRACT

An ion exchange apparatus for use during a glass strengthening chemical process comprising a base, a bath access component, and a pin-spring assembly. The base is configured to support one or more glass sheets and includes a plurality of holes. The bath access component is coupled to the base and has an upright orientation. The pin-spring assembly includes a first pin, a spaced-apart second pin, and a spring having a plurality of coils. The spring is positioned between the two pins and is coupled to each pin. The pin-spring assembly is attached to the base such that the first pin is positioned in a first hole and the second pin is positioned in a second hole. The spring is configured to receive and retain each of the one or more glass sheets between adjacent coils of the spring.

### FEDERALLY SPONSORED RESEARCH AND DEVELOPMENT

This invention was made with Government support under Contract No.: DE-NA0002839 awarded by the United States Department of Energy/National Nuclear Security Administration. The Government has certain rights in the invention.

### FIELD OF THE INVENTION

Embodiments of the current invention relate to apparatuses for strengthening glass, specifically, glass strengthening chemical processes and methods of fabrication of the apparatus.

### BACKGROUND OF THE INVENTION

Chemically strengthened glass is a glass in which properties such as compressive strength have been increased, as compared with untreated glass, utilizing a chemical process. Uses for chemically strengthened glass include displays, such as smartphone or tablet screens, optics, such as lenses, and more general usage in fields such as automotive, marine, military, semiconductor, optical, lighting, petrochemical, industrial, medical, and construction. Processes for chemically strengthening glass include placing glass sheets or panes in a chemical bath in which an ion exchange occurs. Traditional apparatuses and handling techniques contacted a large surface area of the glass during the process, resulting in portions of the glass not being fully strengthened. In other situations, the glass may have been allowed to float on the surface of the bath, also resulting in portions of the glass not being fully strengthened.

The background discussion is intended to provide information related to the present invention which is not necessarily prior art.

### SUMMARY OF THE INVENTION

Embodiments of the current invention address one or more of the above-mentioned problems and provide a distinct advance in the art of ion exchange apparatuses and methods of their fabrication. An exemplary ion exchange apparatus includes a pin-spring assembly which retains glass sheets in between coils of a spring, that significantly reduces the surface area over which the glass sheets are handled during the chemical strengthening process—thus, more fully strengthening each glass sheet. The ion exchange apparatus further includes a base and a bath access component. The base is configured to support the glass sheets and includes a plurality of holes. The bath access component is coupled to the base and has an upright orientation. The pin-spring assembly includes a first pin, a spaced-apart second pin, and a spring having a plurality of coils. The spring is positioned between the two pins and is coupled to each pin. The pin-spring assembly is attached to the base such that the first pin is positioned in a first hole and the second pin is positioned in a second hole.

Another embodiment of the current invention provides an ion exchange apparatus for use during a glass strengthening chemical process. The ion exchange apparatus comprises a base, a pole, and a pin-spring assembly. The base has a circular disc shape and is configured to support one or more glass sheets and includes a plurality of through holes. The through holes are positioned in an orthogonal grid configuration. The pole is coupled to the base and has an upright orientation. The pole includes an opening in an upper end thereof. The pin-spring assembly includes a first pin, a spaced-apart second pin, and a spring. Each pin includes a head coupled to a shaft. The spring has a plurality of coils, is positioned between the two pins, and is coupled to each pin. The pin-spring assembly is attached to the base such that the first pin is removably positioned in a first through hole and the second pin is removably positioned in a second through hole. The spring is configured to receive and retain each of the one or more glass sheets between adjacent coils of the spring.

Yet another embodiment of the current invention provides a method for fabricating an ion exchange apparatus for use during a glass strengthening chemical process. The method comprises the steps of: forming a plurality of holes in at least an upper surface of a base; attaching a bath access component to the base; and attaching a spring to a first pin and a second pin to form a pin-spring assembly.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the current invention will be apparent from the following detailed description of the embodiments and the accompanying drawing figures.

### BRIEF DESCRIPTION OF DRAWINGS

Embodiments of the current invention are described in detail below with reference to the attached drawing figures, wherein:

FIG. 1 is an upper perspective, partially exploded, view of an ion exchange apparatus constructed in accordance with various embodiments of the current invention, to be used during a glass strengthening chemical process, the ion exchange apparatus comprising a base, a pole, and a pin-spring assembly that has been separated from the base;

FIG. 2 is an upper perspective view of the ion exchange apparatus wherein the pin-spring assembly is coupled with the base;

FIG. 3 an upper perspective view of the ion exchange apparatus wherein one or more glass sheets are retained by pin-spring assembly in preparation for the glass strengthening chemical process; and

FIG. 4 is a listing of at least a portion of the steps of a method for fabricating an ion exchange apparatus for use during a glass strengthening chemical process.

The drawing figures do not limit the current invention to the specific embodiments disclosed and described herein. The drawings are not necessarily to scale, emphasis instead being placed upon clearly illustrating the principles of the invention.

### DETAILED DESCRIPTION OF THE INVENTION

The following detailed description of the technology references the accompanying drawings that illustrate specific embodiments in which the technology can be practiced. The embodiments are intended to describe aspects of the technology in sufficient detail to enable those skilled in the art to practice the technology. Other embodiments can be utilized and changes can be made without departing from the scope of the current invention. The following detailed description is, therefore, not to be taken in a limiting sense. The scope of the current invention is defined only by the appended claims, along with the full scope of equivalents to which such claims are entitled.

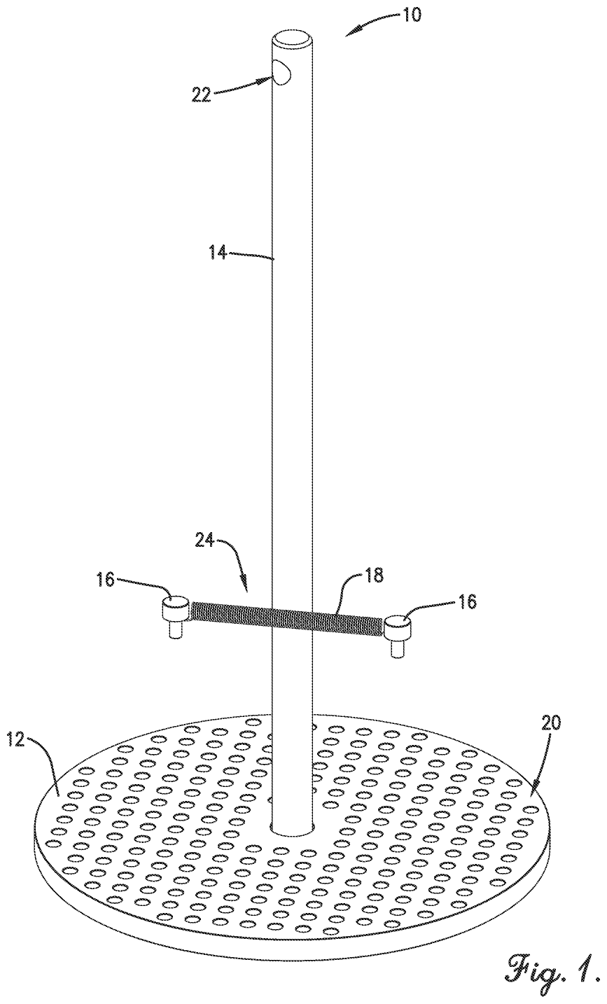

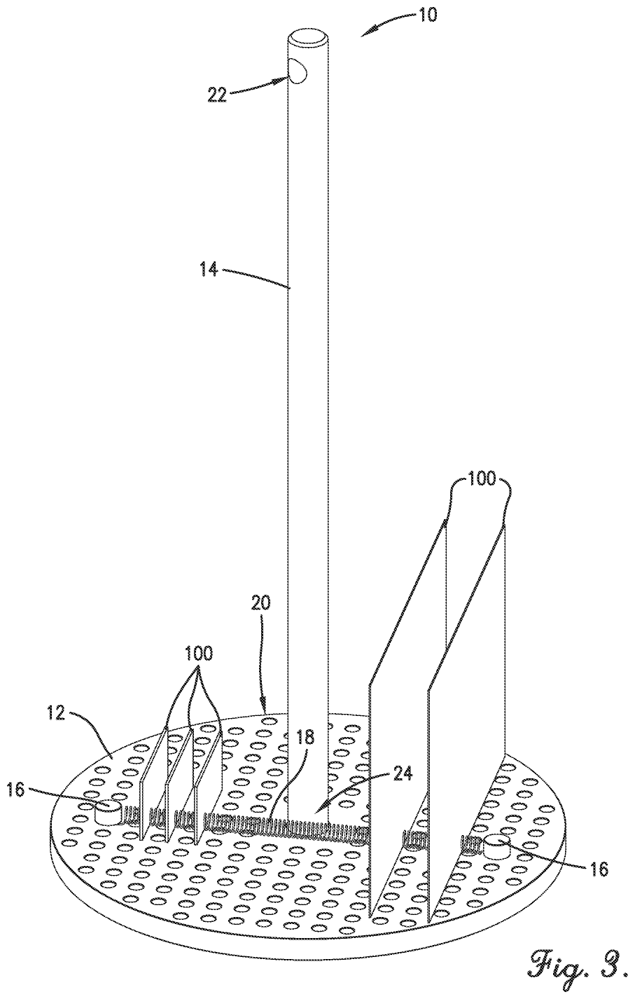

An ion exchange apparatus 10, constructed in accordance with various embodiments of the current invention, is shown in FIGS. 1-3. The ion exchange apparatus 10 is used to retain one or more glass sheets 100 during a glass strengthening chemical process that involves ion exchange. The glass sheets 100 may include types of sheet glass, flat glass, or plate glass that have nearly any composition. Exemplary glass sheets 100 may have a higher magnesium oxide and sodium oxide content than container glass, and a lower silica, calcium oxide, and aluminum oxide content. In addition, the glass sheet 100 may be formed from the five standard glass formers—silica, phosphate, borosilicate, chalcogenide, and germanium. The glass sheets 100 may be of nearly any size or shape that will fit into a chemical solution bath. Exemplary embodiments of the glass sheets 100 shown in FIG. 3 each have a quadrilateral shape with two glass sheets 100 being of a larger size and four glass sheets 100 being of a smaller size. During the glass strengthening chemical process, the glass sheets 100 are placed in a bath (tank) of molten potassium salt (typically potassium nitrate). The glass sheets 100 generally include a distribution of smaller ions that are typically alkali. The bath generally has a concentration of larger ions that are also typically alkali and exchange, at least in part, with the ions of the glass sheets 100. In exemplary instances, the glass sheets 100 include a distribution of sodium ions. Those sodium ions that are present near the surface migrate out from the glass and into the bath. Potassium ions generated by the high energy of the bath migrate into the glass and occupy the positions vacated by the sodium ions. The potassium ions are larger in size than the sodium ions, and as a result, the surfaces of the glass sheets 100 are in compression after the ion exchange event thereby strengthening the glass sheets 100.

The ion exchange apparatus 10 broadly comprises a base 12, a bath access component 14, at least two pins 16, and at least one spring 18. Each component is formed from a non-corrosive material, such as passivated stainless steel. The base 12 generally supports the glass sheets 100 and may have nearly any size or shape that will fit into the chemical solution bath—although, typically the shape of the base 12 should match a shape of an interior of the chemical solution bath. Exemplary embodiments of the base 12 have a circular, disc shape with a small thickness, including an upper surface and a lower surface. Other geometric shapes, such as triangular, quadrilateral, polygon, etc., of the base 12 are also possible. In addition, the base 12 includes a plurality of holes 20. Each hole 20 may extend from the upper surface through a portion of the thickness of the base 12, or each hole 20 may be a through hole extending from the upper surface to the lower surface. In some embodiments, the base 12 may include a combination of holes 20 that extend all the way through the base 12 and holes 20 that do not. Furthermore, in certain embodiments, at least some of the holes 20 may be threaded in order to receive a screw or a bolt. The holes 20 are spaced apart from one another and exemplary embodiments of the holes 20 are laid out on an orthogonal (XY) grid, although other configurations of hole 20 layout are possible such as radial bolt spacing, hexagonal grid, or the like. Each hole 20 is configured to receive one pin 16 and is sized accordingly. No holes 20 are positioned in the vicinity of the center of the base 12.

The bath access component 14, allows the ion exchange apparatus 10 to access, that is, be lowered into, and raised from, the chemical solution bath. An exemplary bath access component 14 includes a pole with a generally elongated cylindrical shape and an opening 22 at one end thereof configured to receive a retrieval device, such as a pulley system, a hook, a rod, or a bar. The bath access component 14 is coupled to the base 12 at roughly a central location thereof and generally normal to the upper surface thereof, such that the bath access component 14 is generally upright.

Each pin 16 includes a shaft having a first diameter that is slightly smaller than a diameter of one of the holes 20, with the shaft being configured to fit into one of the holes 20. Each pin 16 further includes a head attached to the shaft and having a second diameter that is larger than the diameter of one of the holes 20. In certain embodiments, the shaft may be threaded in order to rotationally couple with (screw into) the hole 20.

The spring 18 may include one of many types of spring in general, with the spring having a plurality of coils. Exemplary embodiments of the spring 18 include an extension spring. Each end of the spring 18 is coupled to a successive one of the pins 16 to create a pin-spring assembly 24.

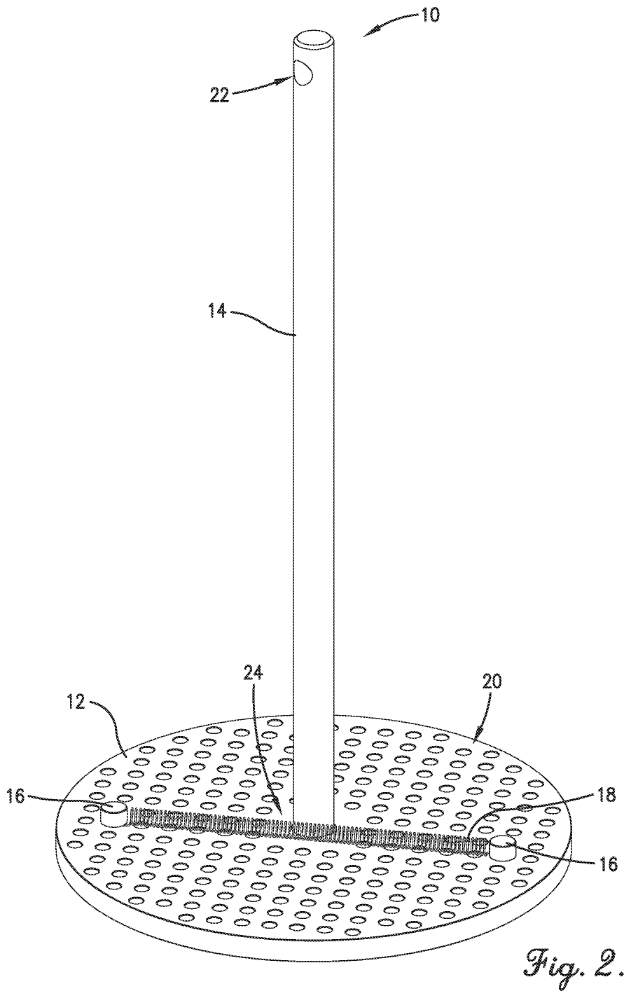

The ion exchange apparatus 10 may be utilized as follows. The pin-spring assembly 24 is attached to the base 12 such that a first pin 16 is positioned in a first hole 20 and a second pin 16 is positioned in a second hole 20. The pins 16 may be positioned such that the spring 18 is pulled into tension and the individual coils are pulled apart to create a space therebetween, as shown in FIG. 2. Additional pin-spring assemblies 24 may be utilized according to the number and/or size of the glass sheets 100 being strengthened. One or more glass sheets 100 are placed in the spring 18 in an upright orientation, such that an edge of each glass sheet 100 is positioned in between adjacent coils of the spring 18, as shown in FIG. 3. The ion exchange apparatus 10 and the glass sheets 100 are gradually heated to a temperature approximately equal to the temperature of the salt bath to avoid thermal shock of immediately going from room temperature to a highly elevated temperature. The retrieval device is placed in the opening 22 of the bath access component 14, and the ion exchange apparatus 10 is lowered into the salt bath. The glass sheets 100, retained in the ion exchange apparatus 10, remain in the salt bath for a period of time while the ion exchange event occurs. After the period of time has elapsed, and the ion exchange event has completed, the ion exchange apparatus 10 is removed from the salt bath and the glass sheets 100 are removed from the spring 18. Given that each glass sheet 100 was retained by adjacent coils of the spring 18, only a small surface area of the glass sheet 100 was contacted during the ion exchange event. Thus, each glass sheet 100 should be more thoroughly strengthened as compared to prior art handling approaches.

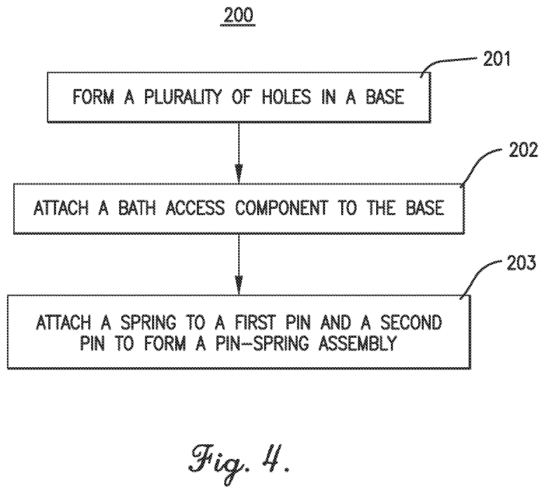

Referring to FIG. 4, at least a portion of the steps of a method 200 for fabricating an ion exchange apparatus 10 for use during a glass strengthening chemical process is shown. Variations to the steps may be performed. The steps may be performed in the order shown in FIG. 4, or they may be performed in a different order. Furthermore, some steps may be performed concurrently as opposed to sequentially. In addition, some steps may be optional or may not be performed.

Referring to Step 201, a plurality of holes 20 are formed in at least an upper surface of a base 12. The base 12 is typically formed from non-corrosive material, such as passivated stainless steel, and has a shape and size that will support the weight of a plurality of glass sheets 100 and fit into a chemical solution bath tank—although, typically the shape of the base 12 should match a shape of an interior of the chemical solution bath. Exemplary embodiments of the base 12 have a circular, disc shape with a small thickness, including an upper surface and a lower surface. Each hole 20 may extend from the upper surface through a portion of the thickness of the base 12, or each hole 20 may be a through hole extending from the upper surface to the lower surface. In some embodiments, the base 12 may include a combination of holes 20 that extend all the way through the base 12 and holes 20 that do not. In some embodiments, the holes 20 may be formed by subtractive means, such as drilling, laser machining, punching, broaching, etching, or the like. In other embodiments, the base 12 may be formed by additive manufacturing processes in which the holes 20 are formed at the same time as the body of the base 12. In certain embodiments, at least some of the holes 20 may be threaded in order to receive a screw or a bolt. The holes 20 are spaced apart from one another and exemplary embodiments of the holes 20 are laid out on an orthogonal (XY) grid, although other configurations of hole 20 layout are possible such as radial bolt spacing, hexagonal grid, or the like. No holes 20 are positioned in the vicinity of the center of the base 12.

Referring to Step 202, a bath access component 14 is attached to the base 12. The bath access component 14 allows the ion exchange apparatus 10 to lowered and raised from the chemical solution bath. An exemplary bath access component 14 includes a pole with a generally elongated cylindrical shape and includes an opening 22 at one end thereof configured to receive a retrieval device, such as a pulley system, a hook, a rod, or a bar. The bath access component 14 is coupled to the base 12 at roughly a central location thereof and generally normal to the upper surface thereof, such that the bath access component 14 is generally upright.

Referring to Step 203, a spring 18 is attached to a first pin 16 and a second pin 16 to form a pin-spring assembly 24. Each pin 16 includes a shaft having a first diameter that is slightly smaller than a diameter of one of the holes 20, with the shaft being configured to fit into one of the holes 20. Each pin 16 further includes a head attached to the shaft and having a second diameter that is larger than the diameter of one of the holes 20. In certain embodiments, the shaft may be threaded in order to rotationally couple with (screw into) the hole 20. The spring 18 may include one of many types of spring in general, with the spring having a plurality of coils. Exemplary embodiments of the spring 18 include an extension spring.

Throughout this specification, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current invention can include a variety of combinations and/or integrations of the embodiments described herein.

Although the present application sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The patent claims at the end of this patent application are not intended to be construed under 35 U.S.C. § 112(f) unless traditional means-plus-function language is expressly recited, such as “means for” or “step for” language being explicitly recited in the claim(s).

Although the technology has been described with reference to the embodiments illustrated in the attached drawing figures, it is noted that equivalents may be employed and substitutions made herein without departing from the scope of the technology as recited in the claims.

Having thus described various embodiments of the technology, what is claimed as new and desired to be protected by Letters Patent includes the following:

1. An ion exchange apparatus for use during a glass strengthening chemical process, the ion exchange apparatus comprising:
a base configured to support one or more glass sheets, the base including a plurality of holes in at least an upper surface thereof;
a bath access component coupled to the base and having an upright orientation; and
a pin-spring assembly including a first pin, a spaced-apart second pin, and a spring having a plurality of coils, the spring being positioned between the two pins and coupled to each pin, the pin-spring assembly attached to the base such that the first pin is positioned in a first hole and the second pin is positioned in a second hole, the spring configured to receive and retain each of the one or more glass sheets between adjacent coils of the spring.

2. The ion exchange apparatus of claim 1, wherein the holes are positioned on the base in an orthogonal grid configuration.

3. The ion exchange apparatus of claim 1, wherein the holes extend through the base from the upper surface to a lower surface thereof.

4. The ion exchange apparatus of claim 1, wherein each pin includes a head coupled to a shaft with the head or the shaft being coupled to the spring, the shaft being removably positioned in the through hole such that each pin can be removably positioned in any one of the through holes.

5. The ion exchange apparatus of claim 1, wherein the bath access component includes a pole having a generally elongated cylindrical shape and an opening in an upper end thereof.

6. An ion exchange apparatus for use during a glass strengthening chemical process, the ion exchange apparatus comprising:
a base having a circular disc shape and configured to support one or more glass sheets, the base including a plurality of through holes, the through holes positioned in an orthogonal grid configuration;
a pole coupled to the base and having an upright orientation, the pole including an opening in an upper end thereof; and
a pin-spring assembly including
a first pin and a spaced-apart second pin, each pin including a head coupled to a shaft, and
a spring having a plurality of coils, the spring being positioned between the two pins and coupled to each pin, the pin-spring assembly attached to the base such that the first pin is removably positioned in a first through hole and the second pin is removably positioned in a second through hole, the spring configured to receive and retain each of the one or more glass sheets between adjacent coils of the spring.

7. A method for fabricating an ion exchange apparatus for use during a glass strengthening chemical process, the method comprising:
forming a plurality of holes in at least an upper surface of a base;
attaching a bath access component to the base; and
attaching a spring to a first pin and a second pin to form a pin-spring assembly.

8. The method of claim 7, wherein the holes are formed in the base in an orthogonal grid configuration.

9. The method of claim 7, wherein the holes extend through the base from the upper surface to a lower surface thereof.

10. The method of claim 7, wherein the bath access component is attached to the base approximately in a center thereof.

11. The method of claim 7, wherein the bath access component includes a pole having a generally elongated cylindrical shape and an opening in an upper end thereof.

12. The method of claim 7, wherein each pin includes a head coupled to a shaft with the head or the shaft being coupled to the spring, the shaft configured to be removably positioned in the through hole such that each pin can be removably positioned in any one of the through holes.
